(19) United States
(12) Patent Application Publication
(10) Pub. No.: US 2013/0315040 A1
(43) Pub. Date: Nov. 28, 2013

(54) CALENDAR OF ACTIVITIES

(71) Applicants: Peter K. Malkin, Ardsley, NY (US); Stanley M. Sutton, JR., Briarcliff Manor, NY (US)

(72) Inventors: Peter K. Malkin, Ardsley, NY (US); Stanley M. Sutton, JR., Briarcliff Manor, NY (US)

(73) Assignee: International Business Machines Corporation, Armonk, NY (US)

(21) Appl. No.: 13/477,571

(22) Filed: May 22, 2012

(51) Int. Cl. G04B 47/00

(52) U.S. Cl. 368/10

(57) ABSTRACT

Representing activities on an electronic calendar, in one aspect, may include receiving a first amount of allocated time for a first type of activity having a duration but not scheduled for a time, receiving a second amount of allocated time for a second type of activity having a duration and a scheduled time, and displaying, in a single representation, a total amount of allocated time for both the first type of activity having a duration but not scheduled for a time and the second type of activity having a duration and a schedule time. Different types, quantities, and qualities of information relating to when the first type of activity and the second type of activity occur may be combined in the single representation.

### FIELD

The present application relates generally to calendaring systems and applications, e.g., electronic calendars and such systems, and more particularly to representing and/or manipulating scheduled and unscheduled activities in a calendar system.

### BACKGROUND

Modern calendaring applications offer a wide range of features. For example, the Lotus Notes™ Calendar offers list and grid views, and views of one day, two days, a work week, a full week, and one month. Lotus Notes™ further allows the representation of several kinds of calendar items, including meetings, appointments, anniversaries, reminders, all day events, event announcements, and to dos.

The Apple Macintosh™ iCal application supports day, week, and month views of multiple calendars (that is, alternative sets of items) that can be related to different areas of concern such as for home and work. It presents a combination of grid and list views. The iCal calendar items are considered events that can be all day events and that can have associated alarms and notifications (invitations).

The Google™ Calendar application supports grid views of a day, four days, week, and month, as well as an “agenda” (list) view of events. Events are associated with particular times within a day (but not to a whole day). Invitations and notifications can be associated with an event. An unusual feature is “appointment slots”, which are times that a calendar user makes available for others to schedule appointments with that user.

Each of these calendaring applications also provides a feature that will let a user check for free time among the invitees to an event, and all address issues such as sharing (access control) and appearance. Each of these also offers some level of integration with an associated email application.

Other calendaring applications offer features similar to these, and traditional paper calendars offer similar grid and list representations for events and to dos. A problem arises, though, because calendaring systems are not the only method of specifying work items or activities to be performed. Software development is an example of a work domain in which an alternative approach may predominate. Consider a software development platform such as Rational Team Concert™. In Rational Team Concert, developers are assigned work items that have an estimated duration (time of effort) and a deadline (due date). A developer typically has several such work items pending. While it is generally understood that activities should be completed by their deadlines, the actual times at which the activities are performed, and even their order and possible interleaving, are not specified in Rational Team Concert.

### BRIEF SUMMARY

A method of representing activities on an electronic calendar, in one aspect, may include receiving a first amount of allocated time for a first type of activity having a duration but not scheduled for a time. The method may also include receiving a second amount of allocated time for a second type of activity having a duration and a scheduled time. The method may further include displaying, in a single representation, a total amount of allocated time for both the first type of activity having a duration but not scheduled for a time and the second type of activity having a duration and a schedule time. In one aspect, different types, quantities, and qualities of information relating to when the first type of activity and the second type of activity occur may be combined in the single representation, and the different types, quantities, and qualities of information relating to when the first type of activity and the second type of activity occur may be associated, interrelated, and compared via the single representation.

An automated system for representing activities on an electronic calendar, in one aspect, may include a storage device operable to store information associated with different types of activities to be represented on the electronic calendar. The different types of activities may comprise at least a first type of activity having a duration but not scheduled for a time and a second type of activity having a duration and a scheduled time. A processor may be operable to convert the stored information into a graphical depiction. A graphical display may be operable to display the graphical depiction of the stored information, the displayed graphical depiction comprising at least a single representation showing a total amount of allocated time for both the first type of activity having a duration but not scheduled for a time and the second type of activity having a duration and a schedule time. A user interface module may be operable to execute on the processor and further operable to enable a user to interact with the graphical display to affect the graphical depiction.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 shows an example representation for a day as constructed according to a method of the present disclosure in one embodiment.

FIG. 2 shows another representation of a day that is constructed according a method of the present disclosure in one embodiment that shows the use of numerals to represent the numbers of unscoped, scoped, and scheduled activities.

FIG. 3 illustrates another example representation of a day showing the representation of additional information associated with activities in one embodiment of the present disclosure.

FIG. 4 shows another example representation, a day D4, in which the representation of scoped and scheduled activities are combined into one column.

FIG. 5 shows an example representation of a week according to a method of the present disclosure in one embodiment.

FIG. 6 shows an example representation of a week with aspects of columns labeled according to a method of the present disclosure in one embodiment.

FIG. 7 shows an example representation of a week with aspects of rows labeled according to a method of the present disclosure in one embodiment.

FIG. 8 illustrates an example representation of a week showing additional information related to activities in one embodiment of the present disclosure.

FIG. 9 illustrates an example representation of a week with representative elements labeled in one embodiment of the present disclosure.

FIG. 10 shows an example representation that provides a summarized representation of a week, e.g., a typical work week, according to a method of the present disclosure in one embodiment.

FIG. 11 shows another example of a summarized representation of a week in one embodiment of the present disclosure.

FIG. 12 is a flow diagram illustrating a method of representing activities on a calendar, in one embodiment of the present disclosure.

FIG. 13 is a block diagram illustrating components of a system of the present disclosure in one embodiment.

FIG. 14 illustrates a schematic of an example computer or processing system that may implement the system in one embodiment of the present disclosure.

### DETAILED DESCRIPTION

Considering calendaring systems together, there are broadly three different notions of things to be done in the following for simplicity called “activities”:
1. “Unscoped” activities, for example, “to dos”, that represent something to be done, but not in a way that is associated with any particular time or that has any expected duration. Examples might be “Delete old emails” and “Schedule inspection for car.”
2. “Scoped” activities, for example, work items in Rational Team Concert. These have an expected duration but not a specific time. Examples might be “Find bug that causes crash on system startup” (which may have an expected duration of four hours) and “Develop next iteration plan” (which may have an expected duration of two hours).
3. “Scheduled” activities, for example, meetings, appointments, and events that are addressed by the typical sorts of calendar items, for example “Weekly group scrum meeting” (scheduled for one hour every Wednesday at 2:00 PM) and “Seminar on New Approaches to Parallel Programming” (scheduled for Monday, 7 November, from 2:00 to 3:30 PM). These sorts of activities have a specified date, time, and duration.

In the present disclosure, the above definitions of the terms “unscoped”, “scoped”, and “scheduled” are used.

One problem that arises from this diversity of activity kinds or types is that no single calendaring representation or application adequately covers them all. As a result, it is generally not possible to look at a person's calendar and see either how many activities the person has pending or how much of their time is allocated to pending activities. A calendar representation does not include scoped activities as such, that is, including both a representation of the activity and of its expected duration, but without specific times. Conversely, a work-item representation does not address scheduled activities, that is, activities that have not only a duration but also an assigned time (although this representation may address unscoped activities as a special case).

A related, although partly independent, problem is that unscoped and scoped activities cannot generally be associated with calendric units, except possibly to days or a range of days. For instance, in the Lotus Notes Calendar, To Dos (unscoped items) can be associated with a day or a range of days but not to a week or a month. In Apple Macintosh iCal, these sorts of items appear in a separate list and are associated with a calendar as a whole but not to any day, week, or month. In the Google calendar, agenda items are just calendar items represented in the form of a list, so the agenda is a list of scheduled activities.

Whereas the first problem described reflects limitations in the representation of the existence and duration of activities, the second problem described reflects limitations in the representation of when activities may occur. As a result of these problems, with conventional approaches to calendars and agendas, it may not be easy, or even possible, for a person to see how many things they have to do, how committed their time is, how much free time they may have, whether they are overcommitted or under committed, and so on.

A system and method may be provided for representing activities on a calendar. Representing activities on a calendar, in one aspect, may comprise displaying, in a single representation, a total amount of allocated time for both a first type of activity having duration but not scheduled for a time and a second type of activity having duration and a schedule time. Such representation may visually depict activities of a certain duration that need not have a specific start time. As such, the activity does not take up any specific time slot on the calendar; however, the user or the software can keep track of how much time is allocated for a given day.

Representing activities may be provided in terms of different kinds, quantities, and qualities of information about the activities that may occur. A system and method may also be provided for combining these representations, into a single representation, so that the different information for different activities is combined, associated, interrelated, and made comparable to the extent that it meaningfully can be. By such a method of representing activities it should be possible to obtain a comprehensive and integrated view of a person's activities, to see a representation of all of their pending activities, to see all of the time that has been allocated to those activities, how much free time they may have, whether they are overcommitted or under committed, and so on.

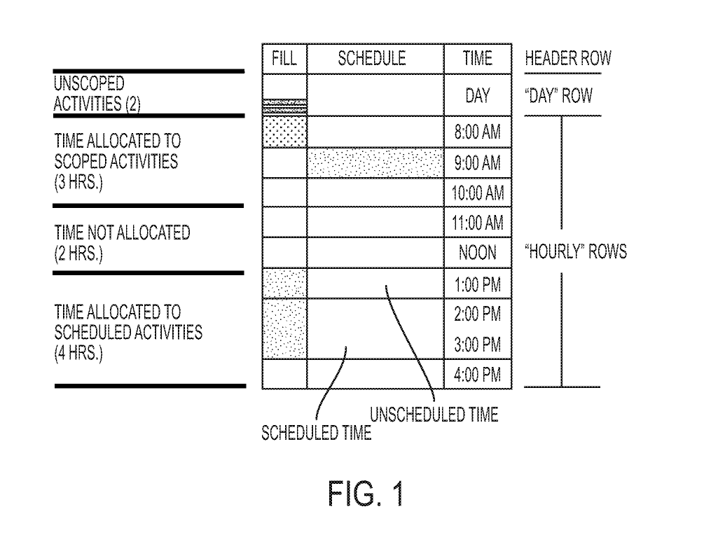

Views produced by applying a method and system of the present disclosure in one embodiment make a comprehensive and integrated representation. Examples of such views are illustrated in FIGS. 1-11. FIG. 1 shows an example representation for a day as constructed according to a method of the present disclosure in one embodiment. An example day (referred to as Day D1) representation shows one layout according to a method of the present disclosure in one embodiment and emphasizes the structure of the representation including the division of the representation into different parts for the representation of different kinds of information about activities.

Example of a Day D1

The example representation of FIG. 1 is illustrated with information for a hypothetical typical day that includes the following activities:
Three scheduled activities, including a one-hour activity beginning at 9:00 AM, a one-hour activity beginning at 11:00 AM, and a two-hour activity beginning at 2:00 PM;
Two scoped (but unscheduled) activities, one with a presumed duration of two hours, and one with a presumed duration of one hour;
Two unscoped activities, with no presumed times or durations.

The illustrated representation has a grid similar to that used in conventional calendars but different in other ways as described below.

General Organization of Rows
The header row contains column headings.
The “day” row is used to represent information associated with the whole day or to no particular time during the day.
The “hourly” rows are used in part to show information associated with particular times during the day and in part to show the allocation of time during the day, as described below.

This is intended to be a representative example. For instance, the “day” may correspond to some other calendric or chronologic unit, and the “hours” may correspond to some other calendric or chronologic unit into which the “day” unit can be subdivided. Additionally, for instance, the full range of times represented by a day or by the hourly rows can vary. Thus, different or alternative chronologic and/or calendric units may be utilized.

General Organization of Columns
The “Time” column contains labels for the rows: “Day” for the day row and times (hours) corresponding to the beginning of the interval represented by each hourly row.

The “Schedule” column represents information that is associated with particular times during the day or with the day as a whole. It may contain additional information.
The “Schedule” column in the day row contains representations of information that is associated with the whole day or with no particular time during the day.
The “Schedule” column in the hourly rows contains representations of information that is associated with particular times or intervals during the day. These rows correspond to the “slots” typically shown in typical representations of calendars.
The “Fill” column represents information about how much time during the day is allocated to activities. It may contain additional information.
The “Fill” column in the day row contains information about “unscoped” activities, that is, activities that are associated with the day and that are expected to require some time but that do not have specified starting times, ending times, or durations assigned.
The “Fill” column in the hourly rows contains information about the amount of time allocated to scheduled activities and to scoped (but unscheduled) activities.
This portion of the “Fill” column, in one embodiment, is not subdivided into hourly (or regular) slots but in its entirety represents the whole period equivalent to that of the hourly rows.
It is filled in parts to an extent that is equivalent or proportional to the time allocated for unscheduled and for scoped activities, but there is no correspondence between the filled portions of this area to the specific times at which activities represented may be performed.

The following describes the details of the example shown in FIG. 1:
The example overall represents a “typical” day with nine hourly rows.
The hourly rows do correspond to hours and are labeled consecutively as beginning from 8:00 AM through 4:00 PM.
The “Schedule” column in the day row contains no information.
The “Schedule” column in the hourly rows contains a representation of the three activities. In this example these activities are given a distinctive rendering in the hourly rows corresponding to the times when those activities are scheduled. In this figure, the rendering is a medium shade of blue not otherwise used except to represent scheduled activities.
The “Fill” column in the day row contains representations of the two unscoped activities (activities without associated times or durations). In this example these activities are each represented by a distinctive bar. In this figure the bars are shaded a very dark blue for purposes of illustration. These activities are not represented elsewhere in the diagram.
The “Fill” column in the hourly rows contains two filled areas with one unfilled area between them.
The bottom part of the column in the hourly range is filled to a height corresponding to four hours in the “Schedule” column and representing the four hours of the scheduled activities represented in that column. In this example, the fill is rendered in the same way as the activities in the “Schedule” column (in this rendering a medium shade of blue). This filled area is subdivided into a number of parts, one for each of the scheduled activities (and no others), and the size of each of these parts is scaled to the duration of the corresponding scheduled activity.
The top part of the column in the hourly range is filled to a depth corresponding to three hours, which is the total time allocated to scoped (but unscheduled) activities in this example. In this example the fill is rendered in a distinctive way that can be distinguished from the renderings for unscoped and scheduled activities (in this case, an intermediate darker shade of blue). This filled area is subdivided into a number of parts, one for each of the scoped activities that are represented (and no others), and the size of these parts reflects the duration of the corresponding scoped activity. These activities are not represented elsewhere in the diagram.
Between the two filled areas of the column in the hourly range of rows, there is an unfilled area that corresponds to the amount of time, in this example, two hours, that is available after the time allotted to scheduled and scoped activities is accounted for (as represented by the filled areas of the column in the hourly range). This is the amount of time that is available, presumably, for unscoped activities and for activities that are not represented at all.

For purposes of clarity, activity details are not shown in the figure; however, it should be understood that the representation may show such details and other information as well. Further, different chronologic and calendric units may be utilized other than day/hour shown in the figure. Moreover, different renderings of the representation may be provided, e.g., other techniques for rendering the representation.

Analysis of the Example in FIG. 1

The use of “hourly” rows allows the representation of activities and events that are associated with specific times, whereas the use of the “day” row allows the representation of activities and events that are associated with the whole day or to no particular time in the day. This allows for the integrated representation of activities and events that:
Are associated with different calendric or chronologic levels (e.g., days and hours),
Do and do not have specific times and intervals.

The use of the “Fill” column allows for a combined representation of all of the activities associated with the day, including scheduled, scoped, and unscoped. Additionally, the part of the “Fill” column corresponding to the hourly rows allows for the combined representation of time allotted to both scheduled activities and unscheduled but scoped activities.

In this way, it is possible by a representation formed according to a method of the present disclosure in one embodiment to see the total set of activities that may occur during the day and the time that has been allotted to those activities. The total set of activities may include some for which no time has been allotted. The amount of time that has not been allotted is also shown.

### Example of a Day D2

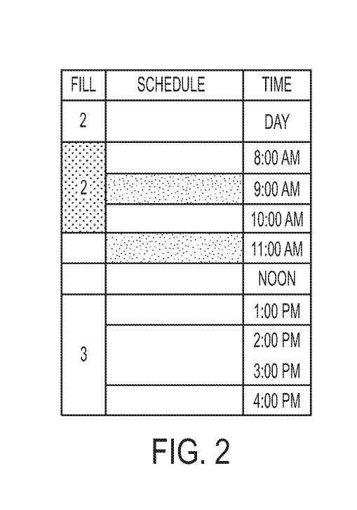

FIG. 2 shows another representation of a day that is constructed by a method of the present disclosure in one embodiment. Example D2 of a representation for a day in FIG. 2 shows the use of numerals to represent the numbers of unscoped, scoped, and scheduled activities. This representation is substantially the same as that in FIG. 1, and reflects the same example data, except that the numbers of unscoped, scoped, and scheduled activities, as represented in the “Fill” column, are shown via numerals rather than by bands (for unscoped activities) or subdivisions of the fill (for scoped and scheduled activities). This example illustrates that a method of the present disclosure in one embodiment encompasses representations in which information is rendered textually in addition to representations in which information is rendered graphically.

Example of a Day D3

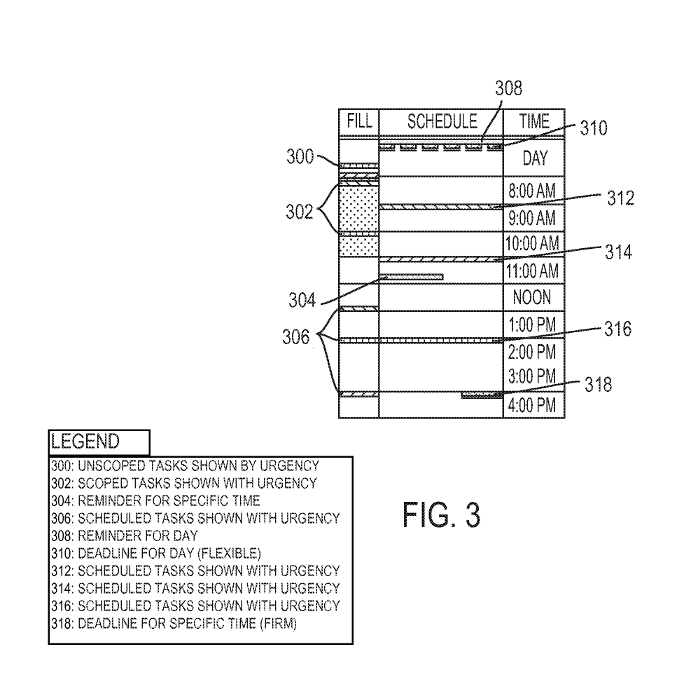

FIG. 3 illustrates another example, Day D3 of representation of a day showing the representation of additional information associated with activities. This example continues Example D1 with the same presentation of the representation (in terms of rows and columns) and the same example scenario (in terms of tasks of various types). This example adds markings to that presentation to represent additional kinds of information. In this example, the markings have the form of colored line segments associated with specific parts of the underlying presentation. This rendering of the additional information is for purposes of illustration only and other renderings may be used.

The added markings in this example represent three different kinds of information not shown in the previous example:
1. The urgency of tasks, shown in this example by line segments, color coded, e.g., colored red (for high urgency), yellow (for moderate urgency), and green (for low urgency).
2. Reminders and alarms, shown in this example by line segments colored orange.
3. Deadlines, shown in this example by doubled line segments colored black, solid for a firm deadline and dashed for a flexible deadline.

In the “Schedule” column in the day row there are markings for a reminder that is associated with the day and a flexible deadline that is associated with the day.

In the “Schedule” column in the hourly rows the scheduled activities all have an urgency marker at the top of their respective filled intervals. For the three scheduled activities in this example, one is red (for a high-urgency activity), one is green (for a low urgency activity) and one is yellow (for a moderately urgent activity).

In the “Schedule” column in the hourly rows there are two additional markings. One is shorter line segment representing an alarm associated with a specific time in the day (actually during an activity scheduled to occur from 11:00 AM to noon). The other is a shorter line segment representing a firm deadline at 4:00 PM.

In the “Fill” column in the day row, two unscoped tasks are each represented by a colored line segment that indicates their urgency (one with moderate urgency and one with low urgency). These may be used instead of the neutral colored bands that were used in the previous example. In this example, the urgency markers are ordered from top-to-bottom according to declining urgency.

In the “Fill” column in the hourly rows, in the areas that are filled corresponding to the durations of scheduled activities and scoped activities, the various activities represented each have an associated urgency marker, such that there is exactly one urgency marker for each task represented in the filled area. The filled area is partitioned into a number of segments, each of which corresponds to exactly one distinct task from among those that are represented in the area. Additionally, each task that is represented in the area has exactly one corresponding segment.

Continuing with the description of the hourly rows in the “Fill” column, each of the segments in the partition of a filled area has a height that corresponds to the duration of the corresponding activity. The urgency markers associated with each activity are placed at the top of the corresponding segment. In this way, the urgency markers are used to demarcate the segments corresponding to activities.

In this example, in the hourly rows in the “Fill” column, within each of the filled areas that represents scheduled and scoped activities, the segments are ordered from top-to-bottom according to the declining urgency of the corresponding activities.

Example of a Day D4

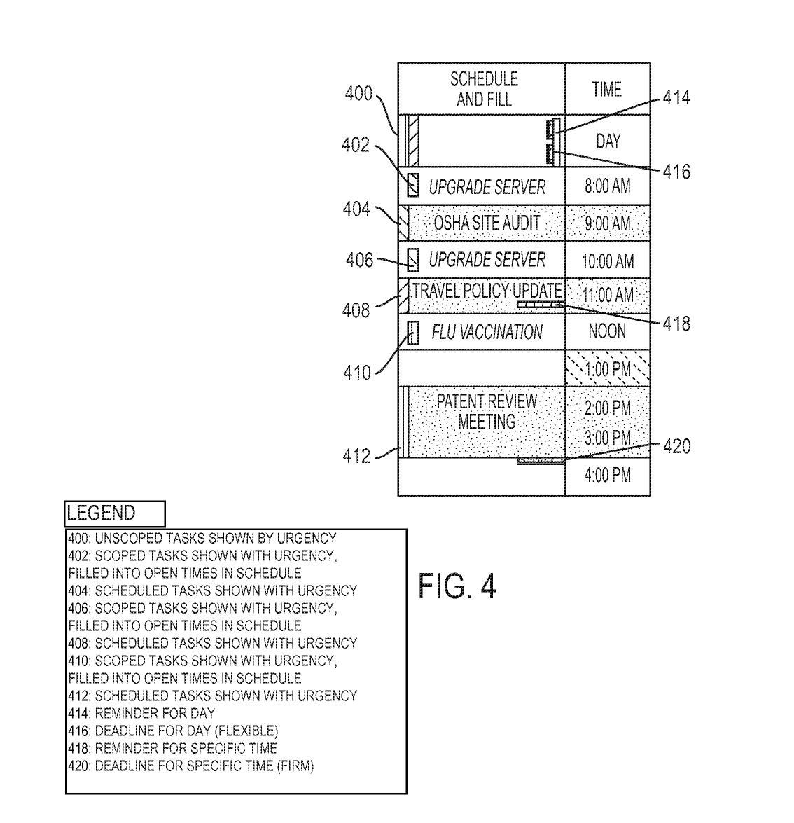

FIG. 4 shows another example representation, a day D4, in which the representation of scoped and scheduled activities are combined into one column. The representation shown in FIG. 4 is similar to Example D3 but with the “Schedule” and “Fill” columns combined into a single “Schedule and Fill” column. This example illustrates some of the variety of specific representations that can be created by a method of the present disclosure in one embodiment.

The “day” and hourly rows are the same as in the previous example, Example 3. The number, duration, and time of scheduled, scoped, and unscoped activities are the same as in the previous example, Example 3. The association of urgency markers, deadlines, and reminders or alarms with activities or with parts of the representation is the same as in the previous example, Example 3. The colors and line styles of urgency markers, deadlines, and reminders or alarms are the same as in the previous example, Example 3.

The changes from Example D3 are as follows:
The “Fill” column has been removed; information about unscoped and scoped activities is shown in the “Schedule and Fill” column.
Unscoped activities are represented in the “Day” row of the “Schedule and Fill” column.
Scoped activities are represented in the rows in the hourly columns that are not used for scheduled activities. Scoped activities are represented by a partial shading of the row in a distinctive color. The shading is full along the left edge of the column. In this example, the shading fades gradually to the right. The shading is absent along the right edge of the column. The effect of this pattern of shading is that the columns that are partially filled appear along the left side of the column to be allocated and appear along the right side of the column to be unallocated.
Urgency markers are represented vertically at or toward the left side of the row in which they occur. Urgency markers for scheduled activities are placed along the left edge of the row and occupy the full height of the interval for the scheduled activity. Urgency markers for scoped activities are placed toward the left side of the interval in which they occur but indented from the edge and are reduced in height so as to not occupy the full interval in which they occur. This has the effect of helping to distinguish scheduled activities from scoped activities and can be interpreted to indicate that the scoped activities are not strictly scheduled for the intervals in the schedule in which they are shown.
Deadlines and reminders or alarms that are associated with the day as a whole are represented vertically in the day row.
Deadlines and reminders or alarms that are associated with particular times in the day are represented by short horizontal line segments at the right side of the “Schedule and Fill” column at a position that is indicative of the associated time.

Example of a Week W1

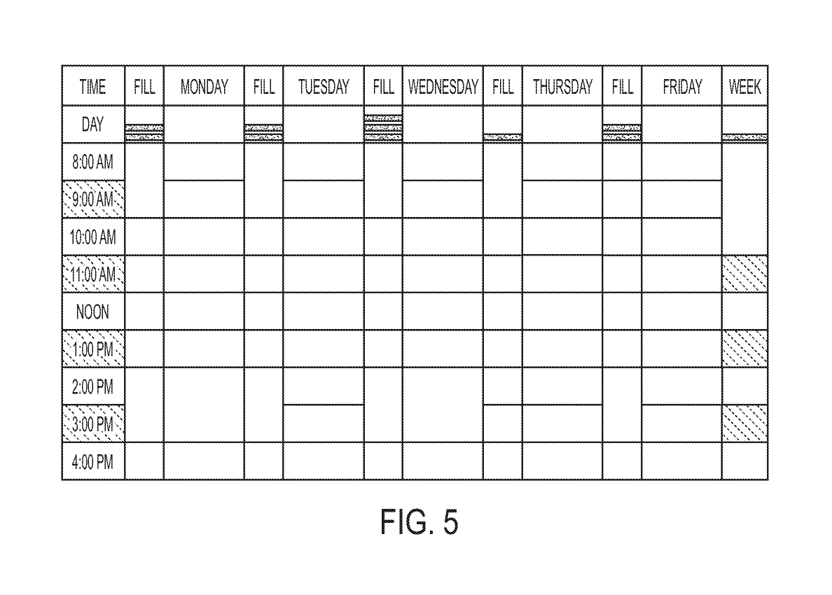

Example of a week W1 provides a representation, according to a method of the present disclosure in one embodiment, of a week. More specifically, this example shows the representation of a typical work week. FIGS. 5, 6 and 7 illustrate this example of a typical work week. FIG. 5 shows an example representation of a week according to a method of the present disclosure in one embodiment. Example W1 shows a weekly representation constructed in part by juxtaposing daily representations of the sort illustrated in Example D1. The daily time scale is in this example presented at the left side of the weekly presentation. A new column, “Week”, is added at the right side of the presentation.

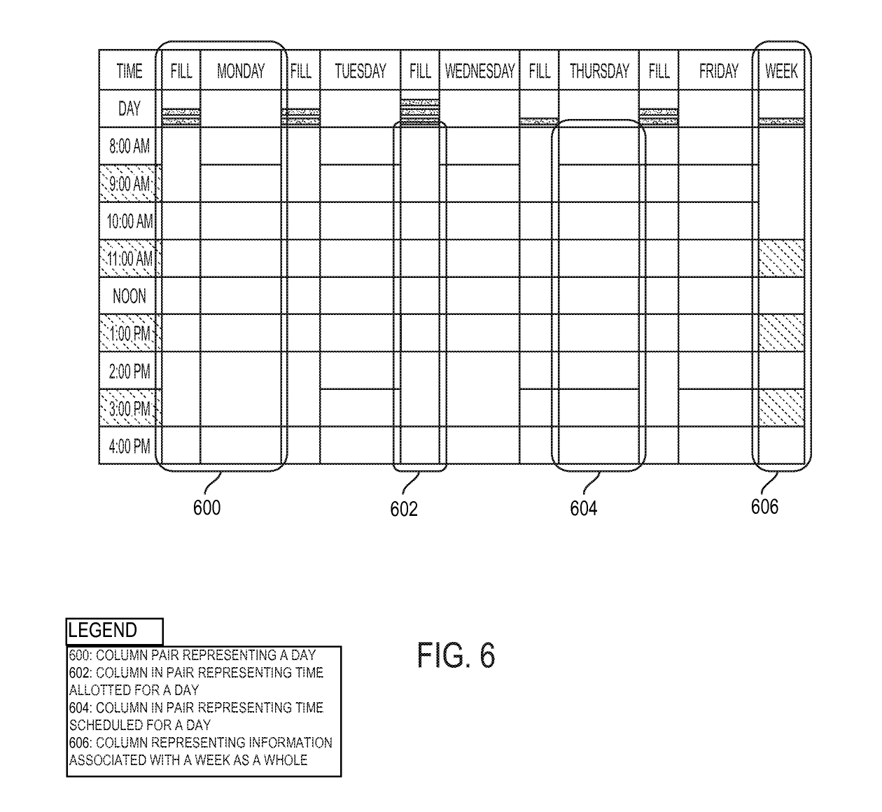

FIG. 6 shows an example representation of a week with aspects of columns labeled according to a method of the present disclosure in one embodiment. In Example W1 (see e.g., FIG. 6), the days of the week are represented by a sequence of five similar representations of days; these are labeled “Monday” through “Friday.” The representation for a day is that used in Example D1 (FIG. 1), including a pair of column. One of these columns is labeled by the name of the day and is used for representing the assigned times and durations of scheduled activities for the day. The other column is labeled “Fill” and is used to represent the amounts of time allotted to scoped and to scheduled activities according to the rendition used in Example D1. These daily columns occupy the largest, central part of the representation for the week.

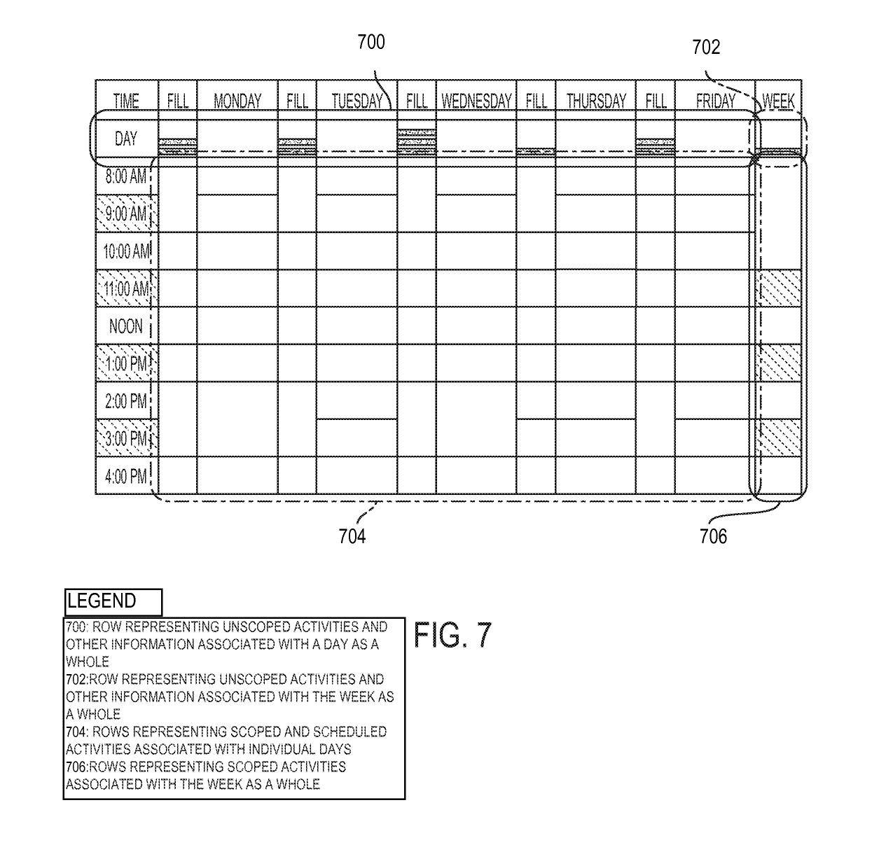

In the representation in Example W1, the rightmost column is labeled “Week” and represents the week as a whole (see e.g., FIG. 6 and FIG. 7). This column is for representing unscoped and scoped activities that are associated with the week but not with any particular day or time. As with the representations for the individual days of the week, the column for the week includes a “day” row and “hourly” rows. In this case, though, the “day” row has the analogous interpretation of a “week” row and is used to represent unscoped activities and related information that are assigned to the week but that are not assigned to any specific day or time. The “hourly” rows are used to represent the individual scoped activities that are allotted during the week but that are not assigned to any specific day or time.

FIG. 7 shows an example representation of a week with aspects of rows labeled. In this example, the representation of activities for “Monday” is the same as that in Example D1 (FIG. 1) and has the same explanation with respect to the representation of unscoped, scoped, and scheduled activities. In this example, the “Week” column shows one unscoped activity in the “Day” row representing one unscoped activity that is associated with the week as a whole. In this example, the “Week” column also shows one scoped activity in the hourly rows that is associated with the week as a whole. In this example, the portion of the “Week” column corresponding to the hourly rows is assumed (for purposes of the example) to have rows corresponding to intervals of one hour. Thus, the scoped activity in the “Week” column is represented as having a duration of three hours.

Example of a Week W2

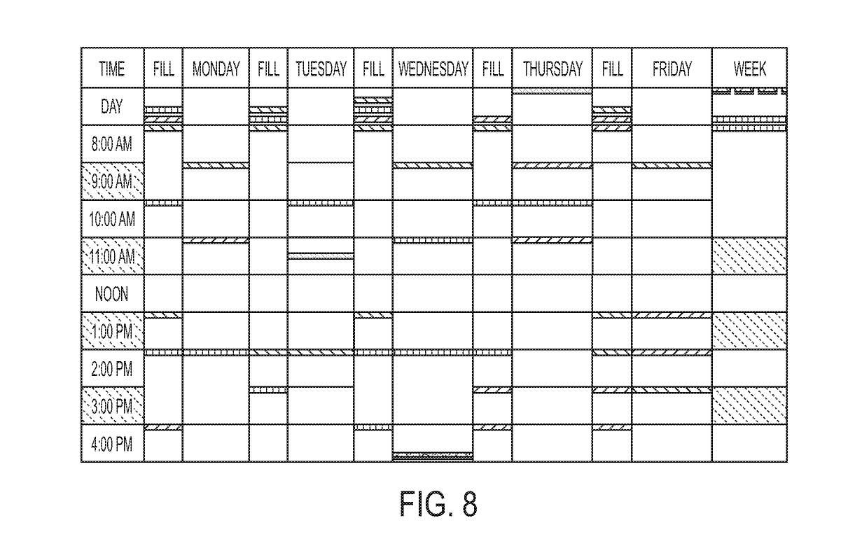

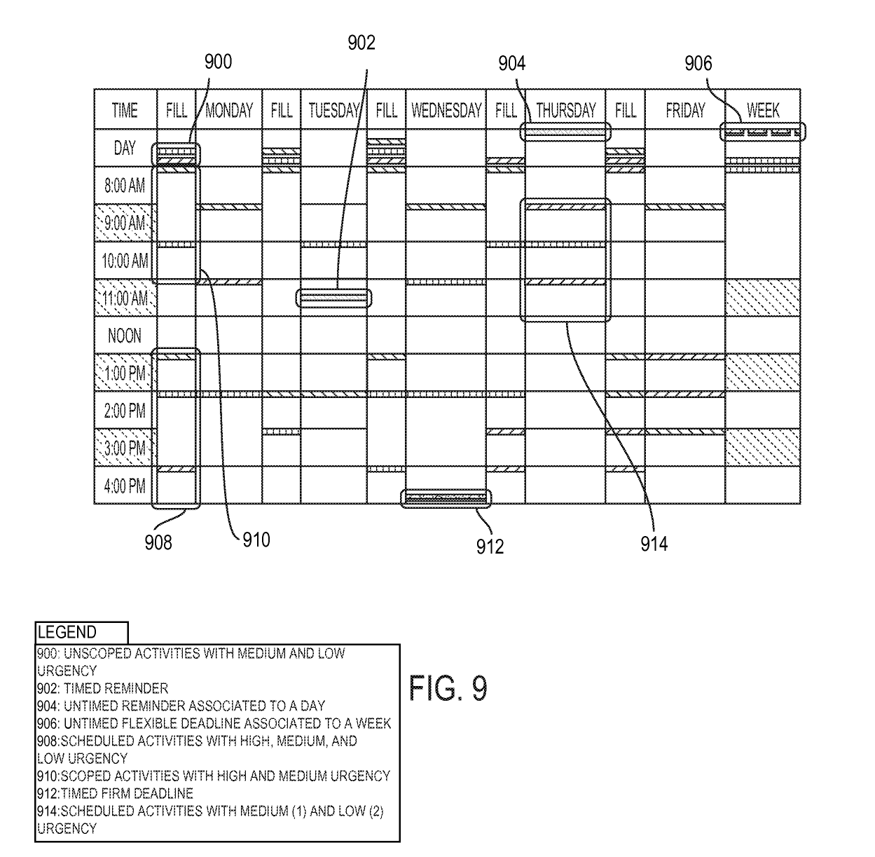

FIG. 8 illustrates an example representation of a week showing additional information related to activities in one embodiment of the present disclosure. FIG. 9 illustrates an example representation of a week with representative elements labeled in one embodiment of the present disclosure. Example of a week W2 is the same as Example W1 but with additional information represented by graphical elements. The representation without any additional labeling is shown in FIG. 8. The representation with specific typical features labeled is shown in FIG. 9.

The additional information as shown in this example includes information about urgency, reminders, and deadlines. The representation of this additional information follows the approach described for Example D3 (FIG. 3). Color coded or other graphically represented codes, e.g., red, yellow and green bars indicate the urgency of activities: red bars indicate high urgency, yellow bars indicate medium urgency, and green bars indicate low urgency. Urgency is shown for all types of activities (unscoped, scoped, and scheduled) and in the columns for days and for the week as a whole. Reminders are shown by orange bars, whereas deadlines are shown by double black bars. A black solid bar indicates a firm deadline, while a dashed double bar indicates a flexible one. Reminders and deadlines can be shown in the schedule column for days and in the “day” row for weeks. See FIG. 9 for labeled examples of these features in the example representation (“timed” deadlines and reminders are ones associated with specific times within the scheduled part of the representation).

Example of a Week W3

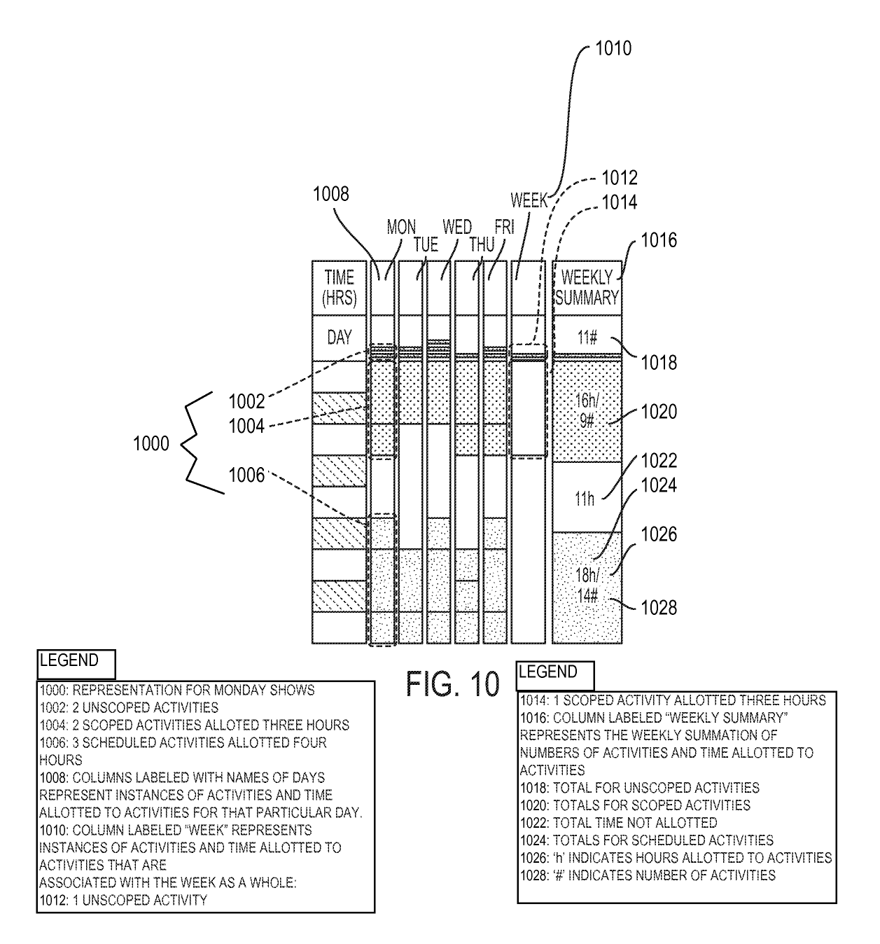

FIG. 10 shows an example representation that provides a summarized representation of a week, e.g., a typical work week, according to a method of the present disclosure in one embodiment. This example representation has four main parts. First, it has a column on the left-hand side that represents time, including a “day” row and “hourly” rows as described previously. Second, and next to the right, it has a series of columns, one for each day of the week. Third, and next to the right, it has a “Week” column that represents the week as a whole apart from any individual days. Fourth, and at the right-hand side, it has a “Weekly Summary” column that represents a weekly summary that combines information from the preceding daily columns and “Week” column.

The columns for the individual days are equivalent to the “Fill” column of the representation of a day given in Example D1. In these columns, the “day” row contains representations of unscoped activities and the “hourly” rows contain representations of scoped and of scheduled activities. For scoped and scheduled activities, areas of the column are filled in scale with the amount of time allotted to those activities and the filled areas are subdivided according to the number and duration of activities represented.

The “Week” column is the same as the “Week” column as described in Example W1 of FIG. 5. The “day” row contains representations of unscoped activities that are associated with the week as a whole. The hourly rows contain a representation of scoped activities that are associated with the week as a whole. For scoped activities, an area of the column is filled in scale with the amount of time allotted to those activities and the filled area is subdivided according to the number and duration of activities represented.

The “Weekly Summary” column is not represented in any of the previous examples. It is similar to a column in this representation that represents an individual day, including a “day” row that represents unscoped activities and hourly rows that are filled in two parts scaled to the amount of time allotted to scoped and to scheduled activities. The numbers and durations of unscoped, scoped, and scheduled activities represented, however, are the sum of those from the daily columns and from the “Week” column. In the representation of Example W3 as rendered in FIG. 10, these sums are shown by numbers and symbols in the corresponding areas of the column. The total duration of non-allotted time is also shown for the week as rendered in the figure.

Variations of the Summary Representation for a Week

Although not illustrated, other representations of a weekly summary can be produced by a method of the present disclosure in one embodiment, e.g., including ones similar to other examples shown for days and for weeks. For instance, individual activities associated with days and to the week as a whole can be marked with their urgency, or deadlines and reminders can be indicated for days and for the week, among other information that may be shown. The “Weekly Summary” can present subtotals of information according to the number and duration of activities with a particular urgency and the numbers of deadlines and reminders, among other information that may be shown.

Example of a Week W4

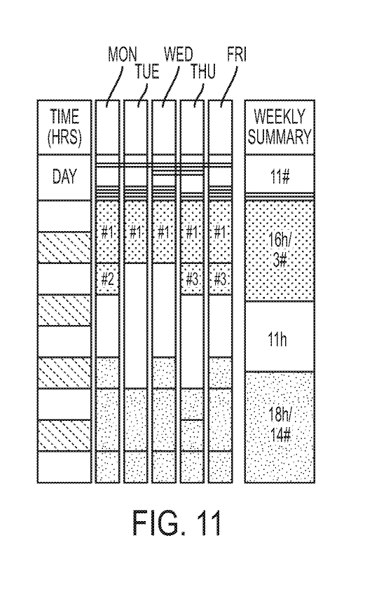

FIG. 11 shows another example of a summarized representation of a week. Example W4 is similar to Example W3. The differences may be that the “Week” column shown in Example W3 has been removed from Example W4 and information that applies to the week as a whole, which is found in that column in Example W3, is distributed across the representation of individual days of the week in Example W4. Size and occurrence of activities are different those shown in Example W3 as well. Specifically:
Unscoped activities that are associated with the week as a whole, or to multiple days, are shown in Example W4 by horizontal bars in the “Day” row that span all of the week as a whole, or some number of days, as appropriate. In the scenario illustrated in FIG. 11, there is one unscoped activity that is associated with the week as a whole and one unscoped activity that is associated with the two days Wednesday and Thursday;
Scoped activities that are associated with the week as a whole, or to multiple days, are shown in Example W4 by “filled” areas in the columns for the individual days, where the total time of the activities is apportioned among the range of days to which the activity is associated. In FIG. 11, the specific scoped activities are designated by identifiers that have a “#” followed by a unique number, for example “#1” to identify an activity that can be referred to as “scoped activity 1.” In the scenario illustrated in FIG. 11, there are three scoped activities, scoped activity 1, which has a total time of 10 hours that are allocated over five days; scoped activity 2, which has a time of 1 hour allocated to one day (Monday), and scoped activity 3, which has a total time of two hours that are allocated over two days (Thursday and Friday).

The representation of scheduled activities is the same in Example W4 as it is shown in Example W3. The Weekly Summary is the same in Example W4 as it is shown in Example W3, except that the specific values of time and number of activities in the summary are adjusted to be consistent with the scenario illustrated in the figure.

Omission of Activity Details in the Examples

The illustrations in all of the examples omit details of specific activities such as may be found in typical calendaring representations. These details include, for example, descriptions of the activities, listings of participants (“invitees”), and information about concerns such as status, category, and priority, possibly among others. The handling of the representation of activity details such as those listed above may occur as is done in a conventional calendaring or other calendaring systems. In this disclosure, the representation of this information is omitted in the above illustrations of examples for the sake of simplicity and clarity. The omission of activity details is intended neither to express nor to imply that such information is not, should not be, or cannot be associated with the representations of the present disclosure as described above. Additional information about specific activities can be made available through some supplemental representation, for example ones typical of calendars, such as by annotation, reference, or other textual or graphical means.

Use of Alternative Chronologic and Calendric Units

The examples illustrated in the present disclosure, for the sake of conveying the general idea of the representation of a methodology of the present disclosure, make use of typical chronologic and calendric units including hours, days, and weeks. More specifically, they make use of typical notions of a work day and work week. However, nothing in the choice of these units for the examples should be taken to express or to imply that the representation of the present disclosure is restricted to these particular chronologic and calendric units. The units in the representation may be any that are appropriate for the scheduling of activities. So, for example, the representation may be used for representing activities in a full (24-hour) day in a full (7-day) week; for representing work shifts in a work day; for representing class periods in a school schedule; for representing weeks in a month or in a year; for representing events during a competition; for representing shows in a television or radio schedule; and other purposes.

Use of Alternative Renderings

The above illustrated examples show several means of rendering the representations of the present disclosure. However, these renderings are only a sample of possible renderings. Renderings may be varied in multiple ways, e.g., including but not limited to the following.

Use of coloring, shading, and patterning of elements: The areas of different kinds of parts of the representation may be rendered in different distinctive ways, including by the use of colors, shading, patterning, shadows, three-dimensional effects, and other effects.

Use of different styles of lines and borders: The borders of different kinds of parts of the representation may be rendered in different distinctive ways, including by different sizes, by different patterns of continuous and discontinuous elements, by different numbers of lines, by different colors or patterns of fill, and other styles that may be applied to lines and borders.

Relative placement of elements: The different kinds of parts of the representation may be located in different relationships to one another in a particular representation. For example, among others, an “Hours” column may be located to the left side or the right side of a representation; a “Fill” column may be located to the left or the right of an associated “Schedule” column; a “Day” row may be located toward the top or the bottom of a representation; within a “Fill” column the representation of scheduled activities may be located toward the bottom or the top and, conversely, the representation of scoped activities may be located at the top or the bottom; within a “Fill” column the representation of scheduled activities and the representation of unscheduled activities may be separated or not separated, and in that case the representation of time not allotted may occur between, above, or below the representations of scheduled and scoped activities.

Size of elements: The different parts of the representation may be of any absolute or relative sizes that may be useful or otherwise desirable.

Use of supplemental graphical or textual elements: In addition to any basic rendering of the representation, supplemental graphical or textual elements may be used to render aspects or details of activities or additional information that may be associated with activities. These supplemental graphical or textual elements may include graphical shapes, icons, and images; graphical renderings of letters, numbers, and other characters; titles, labels, and annotations; links, references, and call outs; and such others as may be useful or otherwise desirable.

In currently known calendaring or activity systems, the diversity of activity kinds, including scheduled, scoped, and unscoped activities, is not adequately represented in a single representation. A method of the present disclosure in one embodiment may address this problem by creating representations that combine scheduled, scoped, and unscoped activities in an integrated way that enables the different kinds of activities to be viewed comprehensively and interrelated. Examples of the representation of the method, such as shown in FIG. 1 (example of a day D1) and in FIG. 5 (example of a week W1) combine representations of scheduled activities, scoped activities, and unscoped activities. The instances and numbers of each type of activity can be seen. The length of time allotted to scheduled and scoped activities can be seen and compared. The amount of time not allotted is also apparent. Representations of scheduled, scoped, and unscoped activities are associated with representations of the times (such as days or weeks) when they are expected to be performed.

As a result, with a representation of a person's calendar created via a methodology of the present disclosure in one embodiment, it is possible to see, for example, the total number of activities, of all types, that they have on their schedule. It is also possible to see how much of their time is allotted to activities, including not only scheduled activities but also activities that are only scoped, and to see how much time is available for unscoped activities.

Also, currently known traditional calendric representations do not give a complete view, or allow a general view, of when unscheduled activities may occur. These activities include scoped activities and unscoped activities. As shown in FIG. 5 (example of a week W1) and in FIG. 11 (example of a week W4), the representations of the example created via a methodology of the present disclosure in one embodiment, allow scoped and unscoped activities to be associated with schedule units at different levels of granularity, such as with days and with weeks.

Additionally, as shown in FIG. 10 (example of a week W3) and in FIG. 11 (example of a week W4) the representation can include summary representations that combine information about activities at different levels of granularity, such as for days and weeks together. Also as shown in FIG. 11 (example of a week W4), representations of activities that may be associated with larger calendric units (such as weeks) can be transformed into representations on smaller calendric units (such as days). The reverse transformation, although not illustrated, is also possible.

As a result, a method of the present disclosure in one embodiment may be used to create a representation of a person's calendar in which it is possible to directly schedule activities at different calendric levels, to view activities scheduled at different calendric levels together in a combined representation, and to relate the activities on one calendric level to those on another level so as to obtain a comprehensive and integrated view of activities that are scheduled and the time that is allotted to activities at multiple calendric levels.

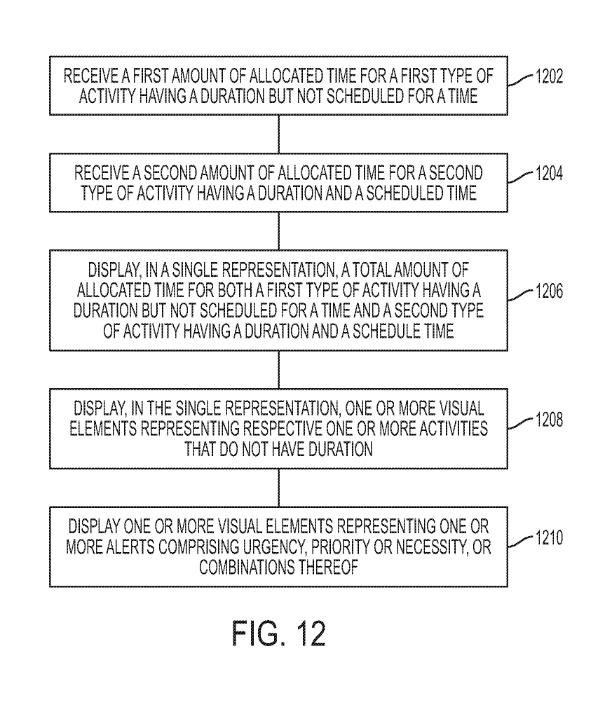

FIG. 12 is a flow diagram illustrating a method of representing activities on a calendar, in one embodiment of the present disclosure. The method may comprise, at 1202, receiving a first amount of allocated time for a first type of activity having a duration but not scheduled for a time. The method may also comprise, at 1204, receiving a second amount of allocated time for a second type of activity having a duration and a scheduled time. The method may comprise at 1206, displaying, in a single representation, a total amount of allocated time for both a first type of activity having a duration but not scheduled for a time and a second type of activity having a duration and a schedule time. The method for representing activities to be performed enables representing different kinds, quantities, and qualities of information relating to when the activities may occur; and combining these representations, into a single representation, so that the different information for different activities is associated, interrelated, and can be compared.

In one aspect, the total amount of allocated time is for a single day. The method may further comprise, at 1208, displaying, in the single representation, one or more visual elements representing respective one or more activities that do not have duration. In one aspect, the single representation displays the first and second activity types on a chart visually depicting the total amount of allocated time attributable to each type of activity. The method may further comprise, at 1210, displaying one or more visual elements representing one or more alerts comprising urgency, priority or necessity, or combinations thereof. In one aspect, the first type of activity may comprise flexible start and end times.

In another aspect, the method may further comprise receiving a third amount of allocated time for a third type of activity having a starting period and an ending period but no duration, wherein the starting period and an ending period includes a starting date and ending date, or a starting time and an ending time, or combinations of both, and wherein the displaying includes displaying by the processor, in a single representation, a total amount of allocated time for the first type of activity having a duration but not scheduled for a time, the second type of activity having a duration and a schedule time, and the third type of activity having a starting period and an ending period but no duration.

In the method of the present disclosure in one embodiment, activities may be represented for which starting dates and times, ending dates and times, and durations are known; activities may be represented for which starting dates, ending dates, and durations are known but not starting times and ending times; activities may be represented for which starting dates and times and ending dates and times are known but not durations; activities may be represented for which starting dates and ending dates are known but not starting times and ending times and not durations. The method in one embodiment also allows for combining the representations of different activities into a single representation such that: representations of activities with respect to when they may occur are associated, interrelated, and comparable; representations of starting dates and times are associated, interrelated, and comparable; representations of ending dates and times are associated, interrelated, and comparable; and representations of durations are associated, interrelated, and comparable.

In one aspect, the starting dates and starting times represent earliest and latest bounds on when the activity may be started. Similarly, the ending dates and ending times represent earliest and latest bounds on when the activity may be ended. Still in another aspect, the starting and ending dates and times and the durations are given a representation of rigidity and flexibility.

The representation of activities may include a representation of urgency, priority, necessity, and other semantic attributes that may be of interest to users of the representation. In another aspect, the representations of when activities may be performed may be specified in terms of chronologic or calendric units of different scales, scopes, and durations, e.g., including seconds, minutes, hours, days, weeks, months, years, and including units of various semantic significance, such as school periods, and also including ranges, selections, and compositions of any of these units. The single representation may include representations of information related to activities where the representations are associated with particular chronologic or calendric units.

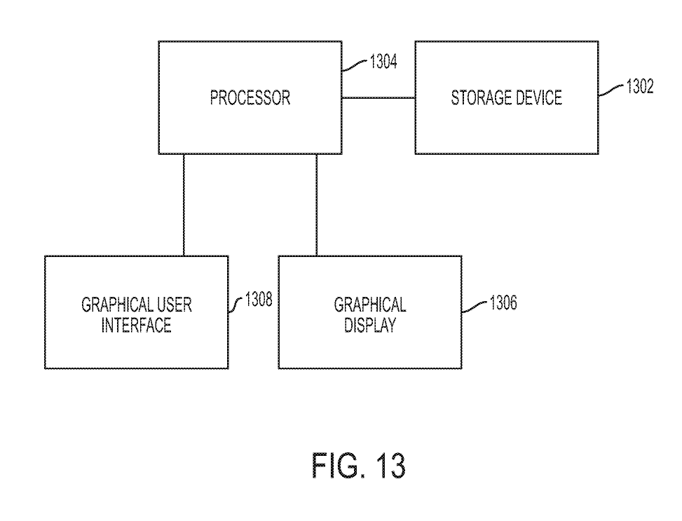

FIG. 13 is a block diagram illustrating components of a system of the present disclosure in one embodiment. A storage device 1302 may include the information to be represented. The storage device operable to store information associated with different types of activities to be represented on the electronic calendar. The different types of activities comprising at least a first type of activity having a duration but not scheduled for a time and a second type of activity having a duration and a scheduled time. A processor 1304 may convert the stored information into a graphical depiction. A graphical display 1306 may be operable to display the graphical depiction of the stored information, the displayed graphical depiction comprising at least a single representation showing a total amount of allocated time for both the first type of activity having a duration but not scheduled for a time and the second type of activity having a duration and a schedule time. A user interface module 1308 may be operable to execute on the processor 1304 and further operable to enable a user to interact with the graphical display to affect the graphical depiction.

In one aspect, the graphical user interface 1308 may enable a user to add, delete, and modify the depicted information; modify the characteristics of a depiction; select from among different available or composable depictions for display; control the display of multiple depictions; and perform other operations on the depictions and the depicted information. By interacting with the graphical display 1306 and the graphical user interface 1308, a user can change the kinds, quantities, and qualities of information that is associated with an activity, for example, including: adding, modifying, or removing information about the starting date and time and ending date and time; adding, modifying, and removing information about the duration; adding, modifying, and removing information about the significance of a starting date and time and an ending date and time as to whether it represents a precise date and time, an approximate date and time, or a bound on the intended date and time; adding, modifying, and removing deadlines, reminders, and other information related to activities; adding, modifying, and removing information about the significance of deadlines as to whether they are firm or flexible; and adding, modifying, and removing information associated with activities as to their urgency, priority, necessity, and other semantic attributes that may be of interest to users of the system.

In one embodiment, the depiction shown in the graphical display is subdivided into different parts, where those parts provide representations of when activities may occur. The representations may be defined in terms of any one or more useful calendric, chronologic, or temporal units or concepts. The units and concepts may be absolute or relative. Those units and concepts may be precise or approximate. Those units and concepts may include any one or more of dates, times, seconds, minutes, hours, days, weeks, months, years, as well as possibly application-relative notions of periods, intervals, measures, phases, seasons, cycles, terms, shifts and watches, as well as any collections or compositions of these, as well as any others that may be useful.

In one embodiment, different parts of the depiction may be used to represent activities that have different characteristic kinds, quantities, and qualities of information, including among others: Parts that represent activities that have associated days but that do not have associated starting times, ending times, and durations; Parts that represent activities that have associated days and durations but that do not have associated starting times and ending times; Parts that represent activities that have associated days, durations, starting times, and ending times; Parts that represent activities that have associated weeks but that do not have associated starting times, ending times, and durations; Parts that represent activities that have associated weeks and durations but that do not have associated starting times and ending times; and Parts that represent activities that have some associated chronologic and calendric units but that do not have other associated chronologic and calendric units. The units may be application specific units, and the units may include but are not limited to dates, times, seconds, minutes, hours, days, weeks, months, years, periods, intervals, measures, phases, seasons, cycles, terms, shifts and watches, and others that may be useful.

In one embodiment, the different parts of the depiction may be graphically related in different ways, such as by any one or more of containment, composition, precedence, exclusion, superposition, and juxtaposition, among others, according to relationships among the different kinds of units and concepts included in the depiction. For example, the representations for the hours of a day may be shown in a chronologic sequence, the representations for the hours of a day may be shown within the representation of that day, and the representations for the days of the week may be shown adjacent to a representation for that week.

In one embodiment, the information associated with a representation in the depiction can be changed by changing the part of the depiction in which the representation is situated, including, among other examples: Changing the situation of an activity representation from a part where the associated activities are also associated with a duration to a part where the associated activities are not also associated with a duration; Changing the situation of an activity representation from a part where the associated activities are not also associated with a part where the associated activities are also associated with a duration; Changing the situation of an activity representation from a part where the associated activities are also associated with a starting time to a part where the associated activities are not also associated with a starting time; Changing the situation of an activity representation from a part where the associated activities are not also associated with a starting time to a part where the associated activities are also associated with a starting time; Changing the situation of an activity representation from a part where the associated activities are also associated with an ending time to a part where the associated activities are not also associated with an ending time; Changing the situation of an activity representation from a part where the associated activities are not also associated with an ending time to a part where the associated activities are also associated with an ending time; Changing the situation of an activity representation from a part where the associated activities are also associated with a day to a part where the associated activities are not also associated with a day; Changing the situation of an activity representation from a part where the associated activities are not also associated with a day to a part where the associated activities are also associated with a day; Changing the situation of an activity representation from a part where the associated activities are also associated with a week to a part where the associated activities are not also associated with a week; Changing the situation of an activity representation from a part where the associated activities are not also associated with a week to a part where the associated activities are also associated with a week; Changing the situation of an activity representation from a part where the associated activities are also associated with a particular sort of chronologic or calendric unit, to a part where the associated activities are not also associated with that particular sort of chronologic or calendric unit, where the units may be application specific units, and where the units may include but are not limited to dates, times, seconds, minutes, hours, days, weeks, months, years, periods, intervals, measures, phases, seasons, cycles, terms, shifts and watches, and others that may be useful; Changing the situation of an activity representation from a part where the associated activities are not also associated with a particular sort of chronologic or calendric unit, to a part where the associated activities are also associated with that particular sort of chronologic or calendric unit, where the units may be application specific units, and where the units may include but are not limited to dates, times, seconds, minutes, hours, days, weeks, months, years, periods, intervals, measures, phases, seasons, cycles, terms, shifts and watches, and others that may be useful.

In one aspect, changes may be made, e.g., by moving (e.g., by dragging and dropping or by any other manipulation or gesture) one or more elements of the graphical depiction from one part of the graphical depiction to another part of the graphical depiction.

As described above, a calendric representation of the present disclosure in one embodiment combines depictions of scheduled activities (e.g., which have a defined both a time slot and duration) and unscheduled but reserved activities (e.g., which lack a time slot but have a defined duration). A system for displaying, storing, and manipulating these representations may include a graphical user interface. A version of the representation and system may also incorporate information about activities that have defined neither a time slot nor a duration. In addition, the extent or bounds of the calendric scale may be changed interactively. Further, priorities can be associated with the activities, and activities can be annotated or categorized in user-defined ways. The method and system of the present disclosure may also enable generating of reports, e.g., on the number, kind, duration, and other characteristics of activities, including for example, among others, the number and duration of activities in different user-defined categories. The representation in another aspect, may incorporate the depiction of deadlines, including firm deadlines and soft deadlines. Moreover, the representation in which activities can be depicted as occurring after a starting time, or before an ending time, or after a starting time and before an ending time.

In another aspect, the representation may display different levels of granularity, so for example, a user might have unscheduled but reserved activities associated with, for example, days, weeks, and months. This concept may be applied independently at different levels of granularity and also at different levels at the same time. For example, a user has two hours of unscheduled work to do today and three more hours of unscheduled work to do this week.

In another aspect, the conception of the calendar can vary. In addition to typical calendric notions, such as hours, days, weeks, the representation of the present disclosure may apply to other sorts of calendars, such as for class periods in a school day in a semester, or for work shifts in a work day, or for events at conference, and others.

The calendar representations and one or more methods thereof, disclosed herein, may also apply to hardcopy calendars.

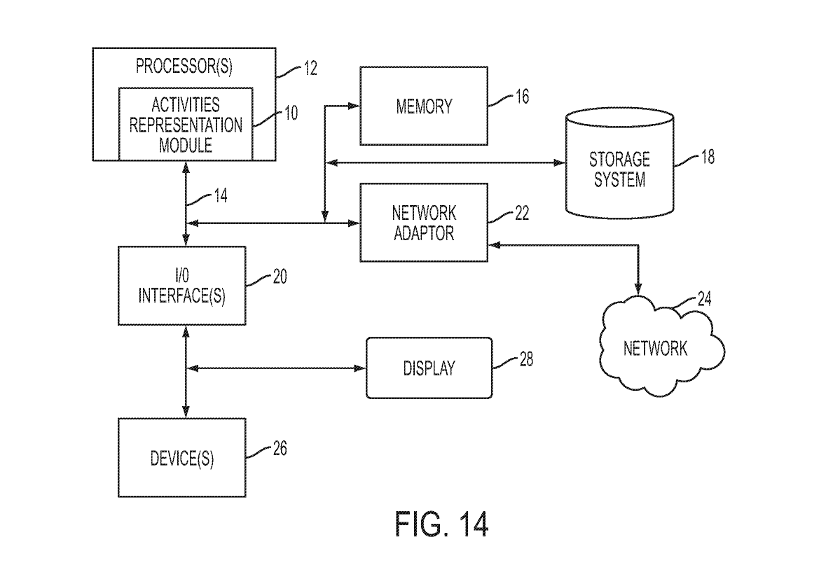

FIG. 14 illustrates a schematic of an example computer or processing system that may implement the system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 14 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include an activities representation module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of representing activities on an electronic calendar, comprising:
receiving a first amount of allocated time for a first type of activity having a duration but not scheduled for a time;
receiving a second amount of allocated time for a second type of activity having a duration and a scheduled time; and
displaying by a processor, in a single representation, a total amount of allocated time for both the first type of activity having a duration but not scheduled for a time and the second type of activity having a duration and a schedule time,
wherein different types, quantities, and qualities of information relating to when the first type of activity and the second type of activity occur are combined in the single representation, and wherein the different types, quantities, and qualities of information relating to when the first type of activity and the second type of activity occur can be associated, interrelated, and compared via the single representation.

2. The method of claim 1, wherein the total amount of allocated time is for a single day.

3. The method of claim 1, further comprising displaying, in the single representation, one or more visual elements representing activities that do not have duration.

4. The method of claim 1, wherein the single representation displays the first and second activity types on a chart visually depicting the total amount of allocated time attributable to each type of activity.

5. The method of claim 1, further comprising displaying one or more visual elements representing one or more alerts associated with urgency, priority or necessity, or combinations thereof.

6. The method of claim 1, wherein the first type of activity comprises flexible start and end times.

7. The method of claim 1, further including:
receiving a third amount of allocated time for a third type of activity having a starting period and an ending period but no duration, wherein the starting period and an ending period includes a starting date and ending date, or a starting time and an ending time, or combinations of both, and
wherein the displaying includes displaying by the processor, in a single representation, a total amount of allocated time for the first type of activity having a duration but not scheduled for a time, the second type of activity having a duration and a schedule time, and the third type of activity having a starting period and an ending period but no duration.

8. An automated system for representing activities on an electronic calendar, comprising:
a storage device operable to store information associated with different types of activities to be represented on the electronic calendar, the different types of activities comprising at least a first type of activity having a duration but not scheduled for a time and a second type of activity having a duration and a scheduled time;
a processor operable to convert the stored information into a graphical depiction;
a graphical display operable to display the graphical depiction of the stored information, the displayed graphical depiction comprising at least a single representation showing a total amount of allocated time for both the first type of activity having a duration but not scheduled for a time and the second type of activity having a duration and a schedule time; and
a user interface module operable to execute on the processor and further operable to enable a user to interact with the graphical display to affect the graphical depiction.

9. The system of claim 8, wherein the user interface module is operable to enable the user to add, delete, and modify information on the graphical depiction, modify a characteristic of the graphical depiction, select from among different available or composable depictions for display, control the graphical display including multiple depictions, and perform an operation on the graphical depiction and the information on the graphical depiction.

10. The system of claim 9, wherein the user interface module enables the user to interact with the graphical display by enabling the user to change kinds, quantities, and qualities of information associated with an activity.

11. The system of claim 10, wherein the graphical depiction displayed on the graphical display is subdivided into different parts including representations of when activities occur, the representations defined in terms of one or more calendric, chronologic, or temporal units.

12. The system of claim 11, wherein the different parts represent activities that have different kinds, quantities, and qualities of information.

13. The system of claim 12, wherein the different parts are graphically related by one or more of containment, composition, precedence, exclusion, superposition, and juxtaposition, according to one or more relationships among different kinds of units included in the graphical depiction.

14. The system of claim 13, wherein the information on the graphical depiction is changed by changing a part of the depiction in which the information is represented in the graphical depiction, or by moving the part of the depiction to another part of the depiction, or combinations thereof.

15. A computer readable storage medium storing a program of instructions executable by a machine to perform a method of representing activities on an electronic calendar, comprising:
receiving a first amount of allocated time for a first type of activity having a duration but not scheduled for a time;
receiving a second amount of allocated time for a second type of activity having a duration and a scheduled time; and
displaying by a processor, in a single representation, a total amount of allocated time for both the first type of activity having a duration but not scheduled for a time and the second type of activity having a duration and a schedule time,
wherein different types, quantities, and qualities of information relating to when the first type of activity and the second type of activity occur are combined in the single representation, and wherein the different types, quantities, and qualities of information relating to when the first type of activity and the second type of activity occur can be associated, interrelated, and compared via the single representation.

16. The computer readable storage medium of claim 15, wherein the total amount of allocated time is for a single day.

17. The computer readable storage medium of claim 15, further comprising displaying, in the single representation, one or more visual elements representing activities that do not have duration.

18. The computer readable storage medium of claim 15, wherein the single representation displays the first and second activity types on a chart visually depicting the total amount of allocated time attributable to each type of activity.

19. The computer readable storage medium of claim 15, further comprising displaying one or more visual elements representing one or more alerts associated with urgency, priority or necessity, or combinations thereof.

20. The computer readable storage medium of claim 15, wherein the first type of activity comprises flexible start and end times.
